(19) United States
(12) Patent Application Publication
(10) Pub. No.: US 2008/0312798 A1
(43) Pub. Date: Dec. 18, 2008

(54) Use of torque converter pump clutch to eliminate vibration jolt in a vehicle transmission

(75) Inventor: Jeremy Whitmer, Columbus, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 12/157,691

(22) Filed: Jun. 12, 2008

Related U.S. Application Data
(60) Provisional application No. 60/934,544, filed on Jun. 14, 2007.

(51) Int. Cl. G06F 17/00

(52) U.S. Cl. 701/60

(57) ABSTRACT

The present invention is a method of engaging a drive gear in a vehicle transmission having a torque converter that reduces the sudden vibration jolt that often accompanies engagement of a drive gear from a neutral position, such as Park or Neutral. The method includes sensing brake pedal depression, detecting shifting from a neutral gear to a drive gear, disengaging a pump clutch in the torque converter, with the pump clutch connecting a pump in the torque converter with a torsional input, such as from an engine, into the torque converter, and gradually engaging the pump clutch, with the gradual engagement occurring after a predetermined period of time after said gear lever shift movement has stopped. Also disclosed is a system that enables operation of the method.

### CROSS-REFERENCE TO RELATED APPLICATIONS

This application claims the benefit under 35 U.S.C. §119(e) of U.S. Provisional Application No. 60/934,544 filed on Jun. 14, 2007 which application is incorporated herein by reference.

### FIELD OF INVENTION

The invention relates generally to torque converters for vehicle transmissions having planetary gears, specifically to the controlled engagement and disengagement of the pump clutch of a torque converter, and more specifically to the use of a pump clutch to reduce or eliminate the vibration jolt or “clunk” caused by the engagement of a transmission drive gear when a vehicle is shifted from a neutral or park condition into a drive gear.

### BACKGROUND OF THE INVENTION

Torque converters are well known components of vehicle transmissions, such as automatic transmissions. Generally, torque converters act to transfer the torque received from an engine through a flywheel or flexplate to the input shaft of an automatic transmission. When a certain speed is reached, the output of the torque converter is coupled directly or indirectly with the engine torsional input by means of a torque converter clutch so that the transmission input shaft and engine rotate at essentially the same speed.

When in park or neutral, the drive gears of the automatic transmission are not engaged, thereby placing the vehicle in a static position in which the torque from the engine does not reach the wheels of the drive train. One frequent problem in the operation of planetary gear transmissions is a sudden vibration, jolt or “clunk” through the vehicle drivetrain that occurs when shifting the gears from the disengaged park or neutral states to engagement with a forward drive gear or a reverse drive gear. This is caused by the torque from the engine being suddenly transferred through the gearbox when transmission is shifted into reverse or a forward drive gear.

U.S. Pat. No. 4,699,259 to McColl discloses the use of a Belleville spring to act simultaneously against both the piston of a torque converter and its cover to relieve the drivetrain of the heavy vibration created when the gear shift moves into a drive gear. However, the system in the '259 patent requires incurring the expense of an extra torque converter part for the torque converter. U.S. Pat. No. 4,224,842 to Rabus, et al. describes a “twice—differentiated” engine speed sensing system in which a change in engine speed activates a control system to reduce vibration caused by gear changes. However, this system depends on a change in engine speed which may occur after a drive gear is engaged and the subsequent vibration has already occurred. Finally, U.S. Pat. No. 3,750,495 to Ito, et al. describes a shift shock control solenoid that controls the engaging and disengaging rate and time of the clutch and brake band to prevent premature engagement of the clutch and brake band to reduce shift shock vibration. Again, like the '842 patent, the system is only activated when the gear shift is moved from one gear to another.

The vibration reduction systems described above are activated at the time the gear shift process starts. Thus, those systems do not start to work until the cause of the vibration is also initiated. Normally, when a vehicle with an automatic (planetary gear) transmission is in Park or Neutral, the operator depresses the brake before shifting to reverse or a forward drive gear. Thus, it would be advantageous to utilize this initial brake action as a signal to start the vibration reduction system before the gear shift lever is actually moved to engage drive gears.

### SUMMARY OF THE INVENTION

The present invention broadly comprises a method to reduce vibration jolt (shift shock or “clunk”) during shifting from a neutral gear to a drive gear in a vehicle drive train. The vehicle drive train includes a torque converter and a vehicular planetary gear transmission. The method includes sensing brake pedal depression, detecting shifting from a neutral gear to a drive gear, disengaging a pump clutch in the torque converter, the pump clutch connecting the torque converter pump with a torsional input into the torque converter, and gradually engaging the pump clutch, with the gradual engagement starting after a predetermined period of time after the gear lever shift movement has stopped.

The present invention also broadly comprises a system to reduce vibration jolt during shifting from a neutral gear to a drive gear in a vehicular transmission. The system includes a torque converter connected to a torsional input, a pump clutch operatively arranged to connect a pump in the torque converter to the torsional input, a brake activation sensing means connected to at least one brake, in which the brake activation sensing means senses activation of the brake, a shift sensing means that senses movement of the gear from neutral or park to a drive gear, a pump clutch control module to control the pressure of fluid in the chamber, and a control means to receive signals from the brake activation sensing means and the shift sensing means and to transmit control signals to the torque converter control module. When the brake activation sensing means detects the activation of the brake and the shift sensing means detects a movement to select a drive gear by the gear shift lever, the pump clutch control module causes the pump clutch to disengage from between the pump and the torsional input.

The torsional or torque input may be a vehicle engine operatively connected to the torque converter. By operatively connected is meant that operation or function of one component is directly or indirectly connected to at least a second component. In this example, the engine and the torque converter are “operatively connected” to each other because the torque from the engine is transferred to the torque converter.

In one embodiment, the vehicle transmission is an automatic transmission.

One object of the invention is to reduce or eliminate vibration jolt when a drive gear of a vehicle planetary gear transmission is engaged from a neutral gear. A neutral gear is a gear in which the transmission is not engaged with the vehicle drive train to enable a car to be propelled forward or backward by the torsion or torque applied by the vehicle engine. “Park” and Neutral” are examples of neutral gears. “Reverse” and forward gears, such as “Drive”, are examples of drive gears.

A second object of the invention is to utilize the pump clutch system of a torque converter to reduce vibration jolt.

A third object of the invention is to utilize the fluid coupling between the pump and turbine of the torque converter to absorb vibration jolt when a drive gear is engaged from a neutral condition.

An additional object of the invention is to provide a method to reduce vibration jolt that incorporates a typical drive gear engagement sequence used by operators of planetary gears transmissions.

### BRIEF DESCRIPTION OF THE DRAWINGS

The nature and mode of operation of the present invention will now be more fully described in the following detailed description of the invention taken with the accompanying drawing figures, in which:

FIG. 1 is a general block diagram illustration of power flow in a motor vehicle, intended to help explain the relationship and function of a torque converter in the drive train thereof;

FIG. 2 is a flow diagram depicting the method of reducing vibration jolt in a vehicle drivetrain comprising a torque converter and a transmission with planetary gears;

FIG. 3 is a cross section drawing of a torque converter that may employ the disclosed method of the present invention; and,

FIG. 4 is a schematic drawing of one embodiment of a control circuit operating the method of the present invention.

### DETAILED DESCRIPTION OF PREFERRED EMBODIMENTS OF THE INVENTION

At the outset, it should be appreciated that like drawing numbers on different drawing views identify identical structural elements of the invention. In addition, while the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

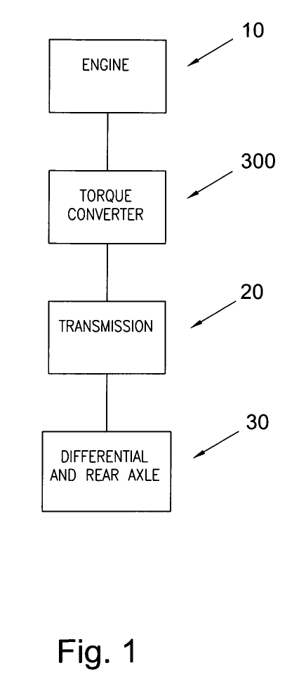

FIG. 1 is a diagram showing interrelationship between an engine 10, a torque converter 302 (seen in more detail in FIG. 9), a transmission 20, and differential and rear axle 30. In torque converter 302, a fluid circuit is created by pump 322, turbine 342, and stator or hub 326. Turbine 342 uses the fluid energy it receives from pump 322 to propel the vehicle. Turbine shell 22 is connected to a turbine hub 19. Turbine hub 326 usually uses a spline connection to transmit turbine torque to transmission input shaft 328. Input shaft 328 is connected to the wheels of the vehicle through gears and shafts in transmission 20 and axle differential 30. The force of the fluid impacting the turbine blades is output from the turbine as torque.

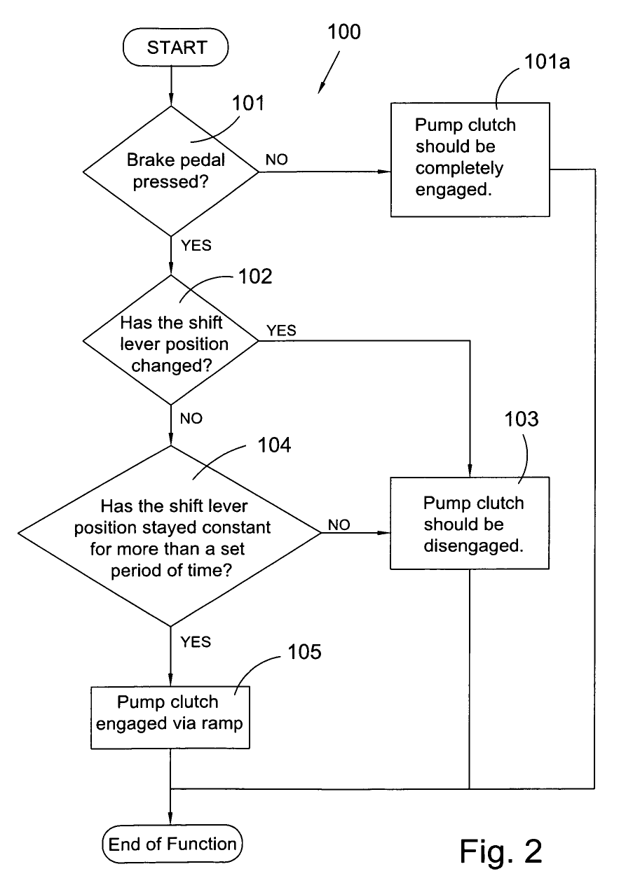

FIG. 2 is a flow diagram depicting method 100 for reducing vibration jolt or “clunk” in a vehicle drivetrain comprising a transmission with planetary gears. It is recognized that in a vehicle equipped with a transmission, such as an automatic transmission, and torque converter, a vehicle operator will normally apply pressure to the brake before moving the gear shift lever to shift the gears from a disengaged condition, such as Park or Neutral, into an “engaged” condition in which either a reverse gear(s) or a forward driving gear(s) is engaged.

Before the initiation of method 100, it will be recognized that the vehicle is in Neutral or Park. At the start of method 100, in sensing step 101, sensors or similar devices, well known to those skilled in the art, detect if or when the brake is activated by pressure from the operator. If the brake is not activated, as in step 101a, the pump clutch in the torque converter is or remains engaged. When engaged, the pump clutch connects the vehicle engine with the pump side of the torque converter. If the sensors detect that the brake has been pressed, at detecting step 102, shift sensing means, such as additional sensors, sense whether the gears are shifting from a neutral gear to a drive gear. If step 101 occurs, namely detecting the brake is activated, the torque converter pump clutch is disengaged at step 103. This prevents any torsion from the engine from being input into the drive train through the torque converter.

At timing step 104, timer(s) determine how long the gear shift lever has been set or stopped in its new position. If the gear shift lever has been set in its new position for greater than a predetermined time period, at connection step 105, the pump clutch is gradually engaged so that the engine is again operatively connected to the torque converter pump. The gradual engagement that takes place at connection step 105 enables the forward or reverse drive gears of the transmission to be engaged with the transmission output drive and the input from the engine without the sudden vibration that causes the disconcerting jolt or “clunk” that often accompanies drive gear engagement from the Neutral or Park states. As discussed below, connection step 105 takes place in the torque converter where the fluid connection between the pump and turbine absorbs the vibration jolt.

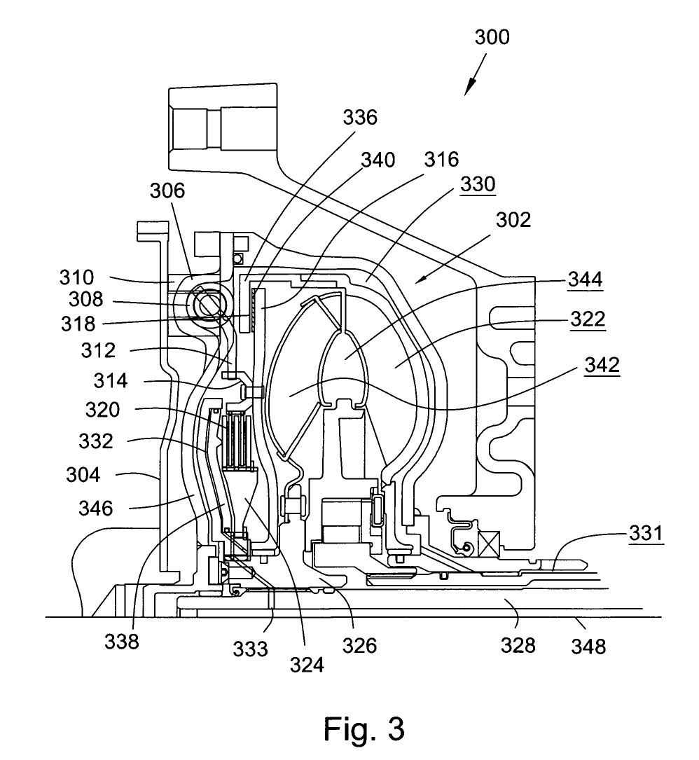

FIG. 3 is a cross section drawing of a torque converter arrangement 300 that may employ the disclosed method of the present invention. FIG. 3 is a partial cross-sectional view of a torque converter clutch arrangement with a three-pass design. By three-pass design, is meant that three fluid circuits may be used in the clutch arrangement. Torque converter 302 is connected to flexplate 304, which in turn is connected to a drive unit (not shown), such as an engine. The drive unit provides torsional input to flexplate 304. Torsional damper 306 includes coil springs 308 and is connected to plate 304 via lugs 310. Flange 312 is connected to spline 314, which in turn is connected to piston or reaction plate 316. Hereinafter, the terms piston and reaction plate are used interchangeably and refer to a structure that moves in reaction to fluid pressures in a torque converter. Pump clutch 318 and torque converter clutch 320 (via spline 314) are connected to piston 316. In some aspects, clutch 320 is a closed-piston type, which minimizes centrifugal pressure effects. Clutch 318 couples the torsional input, through piston 316, to pump 322. Clutch 320 is connected to plate 324, which is connected to hub 326. Hub 326, in turn, is connected to input shaft 328. Clutch 320 couples the torsional input to shaft 328.

In a neutral gear, such as Park or Neutral, fluid pressure in fluid channel or fluid chamber 330 (the terms fluid channel and fluid chamber are used interchangeably hereinafter) is decreased causing pump 322 to move axially toward the transmission (not shown) (left to right in FIG. 3). Channel 331 is in fluid communication with chamber 330 to provide both an inlet and outlet for fluid to enter and leave fluid chamber 330. By fluid communication is meant that different parts or areas of a device are connected to each other or are in proximity with each other to hold or be surrounded by the same fluid. Thus channel 331 is in fluid communication with chamber 330 as fluid moves into or out of chamber 330 from or into channel 331. Similarly, reaction plate 316 and plate 336 are in fluid communication with each other as they are bathed by the same fluid in chamber 330. This fluid movement causes clutch 318 to engage. Plate 336 moves left to right to engage piston 316. This movement causes piston 316 and plate 336 to lockup resulting in torsional input being coupled to pump 322.

To initiate method 100, the vehicle operator depresses the brake. Sensors sense the brake depression and open fluid channel 330. The increased pressure in channel 330 causes pump 322 to move axially toward the drive unit (right to left in FIG. 9), causing plate 336 to move away from piston 316, disengaging pump clutch 318. Low pressure in channel 332, present while the vehicle is in the idle mode, causes plate 338 to remain disengaged from torque converter clutch 320. Therefore, both clutches are disengaged and neither pump 322 nor shaft 328 is engaged with the torsional output. Therefore, while the brake is depressed and simultaneously, the gear shift lever is moved, the load is reduced on the drive unit. By simultaneous is meant that both actions do not necessarily start at the same time, but they do share a common time period when both actions are ongoing.

After shifting the transmission into reverse or a forward drive gear, the gear shifting movement stops. After a predetermined period of time following the stoppage of the gear shifting, pump clutch 318 in converter 302 is reengaged by decreasing pressure in channel 330, causing pump 322 to move axially toward the transmission (not shown) (left to right in FIG. 3). In some embodiments, the predetermined time may be zero seconds. This movement causes clutch 318 to engage. That is, plate 336 moves left to right to engage piston 316. In FIG. 3, friction material 340 is shown on piston 316 and causes piston 316 and plate 336 to lockup. The aforementioned lockup results in torsional input being again coupled to pump 322. Preferably the reengagement of clutch 318 is in the form of a gradual ramping up so as to prevent a sudden engagement of the input torsion of the engine with the drive gears of the transmission. The fluid coupling in torque converter 302 between pump 322 and turbine 342 absorbs vibration jolt as pump clutch 318 is engaged. It should be understood that friction material also could be placed on plate 336 or on both piston 316 and plate 336. Preferably, after pump clutch 318 is engaged, the brake pedal is released. Clutch 320 remains disengaged. Therefore, output shaft 328 is driven by the fluid connection of pump 322 and turbine 342.

Sensors that detect the physical movement of the brake and gear shift lever and convert them into electrical signals are well known in the art. In addition, solenoids actuated by pulse width electrical current used in conjunction with torque converters and planetary gear transmissions are also well known to persons having skill in the art. Examples are seen in U.S. Pat. No. 5,029,087 to Cowan, et al. and U.S. Pat. No. 6,840,361 to Jackson, both of which are hereby incorporated by reference in their entirety. Thus, while the brake is still depressed, a pulse width actuated solenoid(s) may be used to gradually decrease pressure in fluid channel 330 to allow clutch 318 to gradually engage with plate 336 creating the ramping effect. Thus, the jolt or clunk often felt through the drive train is eliminated by allowing the engine torque to be gradually, rather than suddenly, input into the transmission through torque converter 302. If the brake is released within the predetermined time period, pump clutch 318 is immediately fully engaged to allow the vehicle to move.

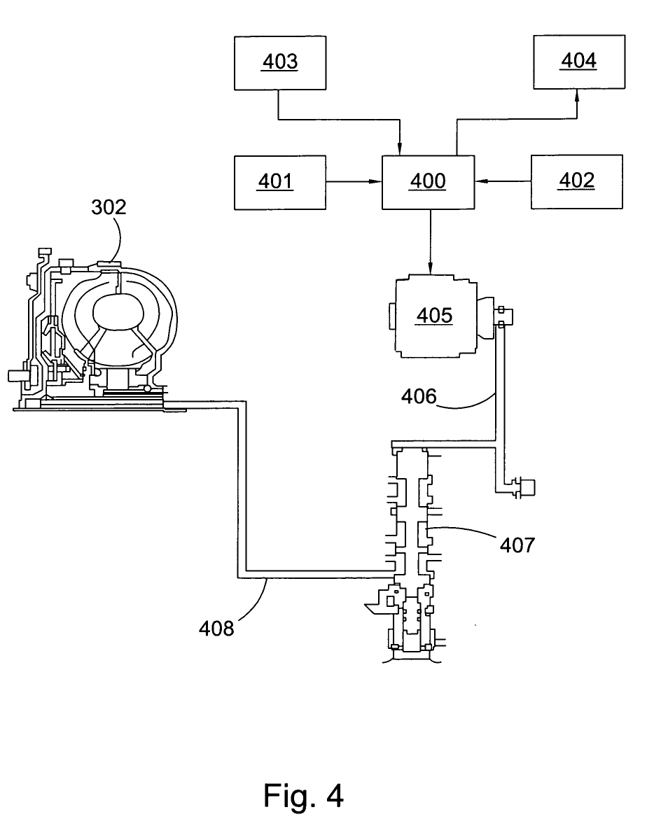

In one example, a control means, such as power control module 400 (“PCM 400”) can receive inputs from a variety of sources, for example a brake activation sensing means such as brake on/off switch 401, transmission control switches 402 that act as gear shift sensing means to detect, for example, when the gears shift lever moves, and timer(s) 403. PCM 400 also transmits signals to control components such as shift solenoids 404, and a torque converter pump control solenoid 405 (“TCPC solenoid 405”). FIG. 4 is a schematic drawing of one embodiment of a control circuit operating method 100 of the present invention. PCM 400 receives signals from brake switch 401. In addition, signals are transmitted to PCM 400 as to whether the transmission is in Neutral or Park. The simultaneous signals cause PCM 400 to signal TCPC solenoid 405 to increase pressure in fluid channel 330 to disengage pump clutch 318 through line 406 to valve 407 and thence to line 408 and torque converter 302. According to method 100, without the brake activation signal, pump clutch 318 in torque converter 302 will not be disengaged while the gear shift lever is moved out of Neutral or Park and into a drive gear. PCM 400 receives information from timer 403 as to how long the gear shift lever has been stopped after moving to engage a drive gear. After a predetermined period of time, PCM 400 activates TCPC solenoid 405 to gradually reengage pump clutch 318 through the lines described above. It will be recognized that other fluid line configurations may be implemented with the same or different components to increase and decrease pressure in the torque converter 302 chambers.

In one embodiment, PCM 400 varies the pulse-width (“on” time) of the electrical signal to TCPC solenoid 405 to control the fluid pressure to torque converter 302. With a zero pulse width (“off”), fluid pressure is zero and pump clutch 318 remains engaged. With a high pulse width signal to TCPC solenoid 405, pressure to torque converter 302 is higher and pump clutch 318 is disengaged. With a moderate and varying pulse width signal, circuit pressure changes result in a gradual ramping up or engagement of pump clutch 318.

It will be recognized that several variations of the above described method 100 can be implemented. For example, it is known that torque converter clutches are engaged and disengaged using differences in pressure between adjacent fluid channels or chambers and that increasing pressure may be utilized to engage a torque converter pump clutch and decreasing pressure to disengage that clutch. Pump clutches may be positioned in various locations within a torque converter. In method 100, the predetermined set time for gear shift movement can be altered. In addition, the present method and system may be used with transmissions operated using mechanical, electrical, or other types of operating systems as well as the hydraulic system discussed above

Thus it is seen that the objects of the invention are efficiently obtained, although changes and modifications to the invention should be readily apparent to those having ordinary skill in the art, which changes would not depart from the spirit and scope of the invention as claimed.

We claim:

1. A system to reduce vibration jolt during shifting from a neutral gear to a drive gear in a vehicular transmission comprising:
a torque converter connected to a torsional input;
a pump clutch operatively arranged to engage a pump in said torque converter to said torsional input;
a brake activation sensing means connected to at least one brake, said brake activation sensing means sensing activation of said brake; and,
a shift sensing means, said shift sensing means sensing shifting from said neutral gear to said drive gear;
a pump clutch control module to control the pressure of fluid in said chamber;
a control means to receive signals from said brake activation sensing means and said shift sensing means to transmit control signals to said pump clutch control module;
wherein when said brake activation sensing means detects the activation of said brake and said shift sensing means detects a shifting from said neutral gear to said drive gear, said control means transmits a control signal directing said pump clutch control module to disengage said pump clutch.

2. The system to reduce vibration jolt during shifting from a neutral gear to a drive gear in a vehicular transmission as recited in claim 1 further comprising a timer, said timer measuring the length of time after said shifting from said neutral gear to said drive gear has stopped.

3. The system to reduce vibration jolt during shifting from a neutral gear to a drive gear in a vehicular transmission as recited in claim 1 wherein said torsional input is an engine.

4. The system to reduce vibration jolt during shifting from a neutral gear to a drive gear in a vehicular transmission as recited in claim 1 wherein said vehicle transmission is an automatic transmission.

5. The system to reduce vibration jolt during shifting from a neutral gear to a drive gear in a vehicular transmission as recited in claim 1 wherein said control means is a power control module.

6. A method to reduce vibration jolt during shifting from a neutral gear to a drive gear in a vehicle drive train, said vehicle drive train having a torque converter and a transmission, said method comprising:
sensing brake pedal depression;
detecting shifting from a neutral gear to a drive gear;
disengaging a pump clutch in said torque converter, said pump clutch when engaged connecting a pump in said torque converter with a torsional input into said torque converter; and,
reengaging gradually said pump clutch, said gradual reengagement starting after a predetermined period of time after said gear lever shift movement has stopped.

7. The method to reduce vibration jolt during shifting from a neutral gear to a drive gear in a vehicle drive train as recited in claim 6, wherein said predetermined time is zero.

8. The method to reduce vibration jolt during shifting from a neutral gear to a drive gear in a vehicle drive train as recited in claim 6 wherein said pump clutch is disengaged during said brake depression.

9. The method to reduce vibration jolt during shifting from a neutral gear to a drive gear in a vehicle drive train as recited in claim 8 wherein said pump clutch is disengaged during said gear shift.

10. The method to reduce vibration jolt during shifting from a neutral gear to a drive gear in a vehicle drive train as recited in claim 6 further comprising releasing said brake pedal from said depression.

11. The method to reduce vibration jolt during shifting from a neutral gear to a drive gear in a vehicle drive train as recited in claim 6 wherein said gradual pump clutch reengagement is initiated by a varying pulse-width electrical signal to a pump clutch solenoid causing said solenoid to apply a gradual change in fluid pressure to said pump clutch.

12. The method to reduce vibration jolt during shifting from a neutral gear to a drive gear in a vehicle drive train as recited in claim 11 wherein said pump clutch solenoid is controlled by a control module.

13. The method to reduce vibration jolt during shifting from a neutral gear to a drive gear in a vehicle drive train as recited in claim 12, wherein said control module receives signals from a brake activation sensing means and a shift sensing means.

14. The method to reduce vibration jolt during shifting from a neutral gear to a drive gear in a vehicle drive train as recited in claim 13, wherein said control module receives signals from at least one timer that said predetermined time period has been exceeded.
